(19) United States
(12) Patent Application Publication
(10) Pub. No.: US 2014/0218395 A1
(43) Pub. Date: Aug. 7, 2014

(54) IMAGE PROCESSOR AND IMAGE PROCESSING METHOD

(71) Applicant: Kabushiki Kaisha Toshiba, Tokyo (JP)

(72) Inventors: Yoshiharu MOMONOI, Yokohama (JP); Kenzo ISOGAWA, Tokyo (JP); Kazuyasu OHWAKI, Tokyo (JP)

(73) Assignee: Kabushiki Kaisha Toshiba, Tokyo (JP)

(21) Appl. No.: 14/172,757

(22) Filed: Feb. 4, 2014

Related U.S. Application Data
(63) Continuation of application No. PCT/JP2013/058740, filed on Mar. 26, 2013.

(30) Foreign Application Priority Data
Feb. 5, 2013 (JP) 2013020912

(51) Int. Cl. G06T 11/00; G06T 3/40

(52) U.S. Cl. CPC G06T 11/00; G06T 3/40
USPC 345/629

(57) ABSTRACT

According to one embodiment, image processor includes generator and superimposing module. The generator generates enlarged image including display area larger than that of input image. The enlarged image is generated by synthesizing first extrapolated image and second extrapolated image with the input image. The first extrapolated image is synthesized with respect to first enlarged area positioned outside of display area of the input image and adjacent to the display area. The first extrapolated image includes continuity with the input image. The second extrapolated image is synthesized with respect to second enlarged area positioned outside the first enlarged area. The second extrapolated image includes pixel gradient smoother than that of the first extrapolated image. The superimposing module superimposes small image on display area in which the first extrapolated image and the second extrapolated image are synthesized. Area of the small image is smaller than that of the second extrapolated image.

### CROSS-REFERENCE TO RELATED APPLICATIONS

This application is a continuation of international application No. PCT/JP2013/058740, filed Mar. 26, 2013, which designates the United States, incorporated herein by reference, and which is based upon and claims the benefit of priority from Japanese Patent Application No. 2013-020912, filed Feb. 5, 2013, the entire contents of which are incorporated herein by reference.

### FIELD

Embodiments described herein relate generally to an image processor and an image processing method.

### BACKGROUND

Conventionally, a television display device tend to support displaying of image data in various formats or various display sizes.

When the display size of the image data is smaller than the resolution of a display provided to the television display device, a blank area, e.g., a black frame, is often displayed around the image data at the when the image data is displayed on the display.

Accordingly, as a technique to utilize the blank area such as the black frame, there has been proposed a technique in which menu items are displayed in the blank area such as the black frame. Such technique can improve usability for users.

There has also been proposed a technique in which the sense of present is emphasized by reproducing the ambient environmental light using the illumination of the display device. However, because such a technology is not very suitable for displaying detailed images, it has been difficult to display a menu in the area around the image data.

In addition to the difficulty in displaying the menu items, according to the conventional technique, even when the menu and the like is displayed in the blank area, there is a tendency that a user cannot concentrate on the image data displayed at the center because the user is caused to be attracted to the blank area.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an example of a configuration of a television display device according to an embodiment;

FIG. 2 is an exemplary schematic diagram of a configuration of some functions provided to an image processor in the embodiment;

FIG. 3 is an exemplary schematic diagram illustrating an example of a video data frame displayed on a display of a conventional television display device;

FIG. 4 is an exemplary schematic diagram for explaining display areas for respective pieces of extrapolated image data extrapolated by the image processor in the embodiment;

FIG. 5 is an exemplary block diagram illustrating a configuration of an extrapolated image base generator in the embodiment;

FIG. 6 is an exemplary flowchart illustrating a process performed by an internal data utilizing extrapolated image generator in the embodiment;

FIG. 7 is an exemplary schematic diagram for explaining image data generated by the internal data utilizing extrapolated image generator in the embodiment;

FIG. 8 is an exemplary schematic diagram illustrating an example of synthesized image data synthesized by a selecting and synthesizing module in the embodiment;

FIG. 9 is an exemplary schematic diagram illustrating an example of output image data resulting from superimposing menu item image data, related item image data, and related content thumbnails over synthesized image data, in the embodiment;

FIG. 10 is an exemplary flowchart illustrating a process performed in the image processor in the embodiment;

FIG. 11 is an exemplary flowchart illustrating a screen switching process performed in a television display device according to a first modification;

FIG. 12 is an exemplary schematic diagram illustrating an example of output image data resulting from performing a process of superimposing pieces of item image data over synthesized image data in which extrapolated image data is synthesized, and reducing the luminance near each of these pieces of item image data, according to a second modification;

FIG. 13 is an exemplary schematic diagram illustrating an example of output image data resulting from performing a process of superimposing pieces of item image data over synthesized image data in which extrapolated image data is synthesized, and applying image processing so as to allow each of the pieces of item image data to appear as casting a shadow, in the second modification;

FIG. 14 is an exemplary schematic diagram illustrating an example of output image data resulting from superimposing pieces of item image data over synthesized image data in which extrapolated image data for decorating the periphery of input image data in an oval shape is synthesized, in the second modification;

FIG. 15 is an exemplary schematic diagram illustrating an example of a first operation performed when a selection of related content is received by a touch panel operation terminal, according to a third modification; and

FIG. 16 is an exemplary schematic diagram illustrating an example of a second operation performed when a selection of related content is received by the touch panel operation terminal, according to a third modification.

### DETAILED DESCRIPTION

In general, according to one embodiment, an image processor comprises a generator and a superimposing module. The generator is configured to generate enlarged image data comprising a display area larger than a display area of input image data. The enlarged image data is generated by synthesizing first extrapolated image data and second extrapolated image data with the input image data. The first extrapolated image data is synthesized with respect to a first enlarged area positioned outside of a display area of the input image data and adjacent to the display area of the input image data. The first extrapolated image data comprises continuity with respect to the input image data. The second extrapolated image data is synthesized with respect to a second enlarged area positioned outside the first enlarged area. The second extrapolated image data comprises pixel gradient that is smoother than pixel gradient of the first extrapolated image data. The superimposing module is configured to superimpose small image data on a display area in which the first extrapolated image data and the second extrapolated image data of the enlarged image data are synthesized. An area of the small image data is smaller than that of the second extrapolated image data.

An image processor and an image processing method according to an embodiment will now be explained in detail with reference to the accompanying drawings. Explained below is an example in which the image processor and the image processing method according to the embodiment is applied to a television display device, but an application is not limited to the television display device.

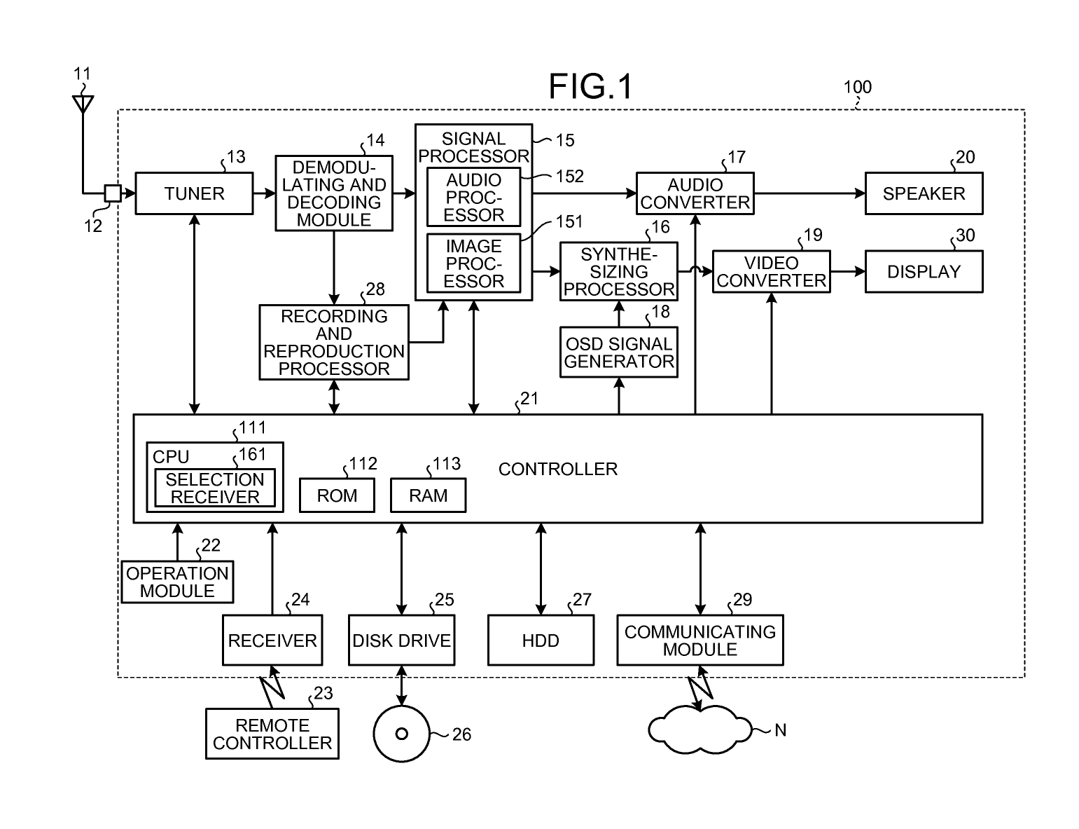

FIG. 1 is a schematic diagram of an example of a configuration of this television display device 100 according to the embodiment. As illustrated in FIG. 1, the television display device 100 supplies broadcast signals received by an antenna 11 to a tuner 13 via an input terminal 12, and allows a user to select a broadcast signal over a desired channel.

The television display device 100 supplies the broadcast signal selected by the tuner 13 to a demodulating and decoding module 14, causes the demodulating and decoding module 14 to decode the broadcast signal into a digital video signal, a digital audio signal, and the like, and to output the signals to a signal processor 15.

The signal processor 15 comprises an image processor 151 that applies predetermined image processing to the digital video signal received from the demodulating and decoding module 14, and an audio processor 152 that applies predetermined audio processing to the digital audio signal received from the demodulating and decoding module 14.

The image processor 151 applies the predetermined image processing for improving the image quality to the digital video signal received from the demodulating and decoding module 14, and outputs the digital video signal applied with the image processing to a synthesizing processor 16. The audio processor 152 outputs the digital audio signal thus processed to an audio converter 17. A detailed configuration of the image processor 151 will be described later.

The synthesizing processor 16 superimposes on-screen display (OSD) signals that are video signals to be superimposed, such as captions, a graphical user interface (GUI), or an OSD generated by an OSD signal generator 18, over the digital video signal received from the signal processor 15 (the image processor 151), and outputs the digital video signal to a video converter 19.

The television display device 100 supplies the digital video signal output from the synthesizing processor 16 to the video converter 19. The video converter 19 converts the digital video signal thus input into an analog video signal having a format that is displayable on a display 30 provided subsequently. The television display device 100 supplies the analog video signal output from the video converter 19 to the display 30 to allow the analog video signal to be displayed. The display 30 has a display device such as a liquid crystal display (LCD), and displays the analog video signal output from the video converter 19.

The audio converter 17 converts the digital audio signal received from the signal processor 15 (the audio processor 152) into an analog audio signal in a format that can be replayed by a speaker 20 subsequently provided. The analog audio signal output from the audio converter 17 is supplied to the speaker 20 so as to allow the speaker 20 to reproduce the audio.

The television display device 100 causes a controller 21 to control the entire operations including various receiving operations described above, in a comprehensive manner. The controller 21 comprises a central processing unit (CPU) 111, a read-only memory (ROM) 112 storing therein computer programs executed by the CPU 111, and a random access memory (RAM) 113 providing a working area to the CPU 111, and the CPU 111 and various computer programs work together to control the operation of each of modules in a comprehensive manner.

For example, the controller 21 realizes a selection receiver 161 by reading a computer program. The selection receiver 161 receives operation information from an operation module 22 provided to the main body of the television display device 100, and also receives operation information transmitted by a remote controller 23 and received by a receiver 24. The controller 21 controls each of the modules so as to reflect the operation.

The controller 21 acquires an electronic program guide (EPG) from a signal decoded by the demodulating and decoding module 14, and provides the electronic program guide to the OSD signal generator 18 or to the video converter 19 to allow listings of programs currently being broadcasted and scheduled to be broadcasted to be provided to the viewer based on a viewer operation performed on the operation module 22 or on the remote controller 23. It is assumed herein that the electronic program guide includes, for each of the programs currently being broadcasted and scheduled to be broadcasted, program information describing details of the program, such as a program identification (ID) for identifying the program (e.g., a broadcast station and broadcasting time), the title and the genre of the program, the summary of the program, and casts.

The controller 21 may be connected with a disk drive 25. On the disk drive 25, an optical disk 26 such as a Blu-ray Disc (BD) (registered trademark) or a digital versatile disk (DVD) can removably be mounted, and the disk drive 25 has a function of recording and reproducing digital data to and from the optical disk 26 thus mounted.

The controller 21 can perform controlling so as to encrypt the digital video signal and the digital audio signal acquired from the demodulating and decoding module 14 by a recording and reproduction processor 28, to convert these signals into a predetermined recording format, to provide such signals to the disk drive 25, and to store the signals in the optical disk 26, based on a viewer operation performed on the operation module 22 or on the remote controller 23.

A hard disk drive (HDD) 27 is connected to the controller 21. The HDD 27 may be configured as an external device. When a viewer selects a program to be recorded via the operation module 22 or the remote controller 23, the controller 21 causes the recording and reproduction processor 28 to encrypt the video signal and the audio signal of the program which can be acquired from the demodulating and decoding module 14 (hereinafter, referred to as program data) to convert the video signal and the audio signal into a given recording format, and supplies the signals to the HDD 27 so that the program is recorded in the HDD 27.

The controller 21 performs controlling for the above-mentioned video displaying and audio reproduction by: reading out digital video signal and digital audio signal from the program data of a program recorded in the HDD 27 or from the optical disk 26 by the disc drive 25, based on an operation of a viewer via the operation module 22 or the remote controller 23; decoding the read out digital video signal and digital audio signal by the recording and reproduction processor 28; and supplying the decoded digital video signal and digital audio signal to the HDD 27.

A communicating module 29 is connected to the controller 21. The communicating module 29 is a communication interface capable of establishing a connection to a network N such as the Internet. The controller 21 exchanges various types of information with an external device (not illustrated) connected to the network N via the communicating module 29.

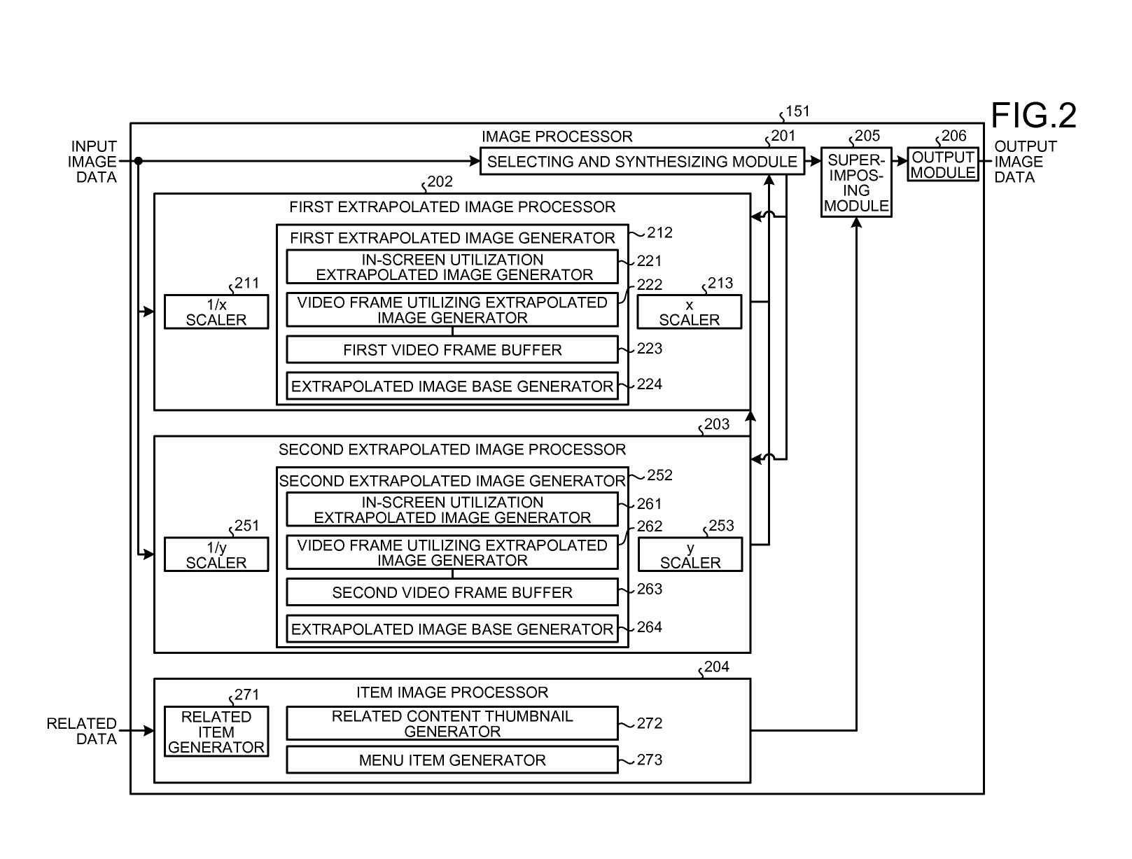

Some functions provided to the image processor 151 will now be explained. FIG. 2 is a schematic diagram of a configuration of some functions provided to the image processor 151. As illustrated in FIG. 2, the image processor 151 comprises a selecting and synthesizing module 201, a first extrapolated image processor 202, a second extrapolated image processor 203, an item image processor 204, a superimposing module 205, and an output module 206, as functional modules related to the image processing of the digital video signals.

Explained in this embodiment is a process performed in units of a video data frame (hereinafter, also referred to as input image data). However, the image data to be processed is not limited to video data, and the image processing may be applied to any (image) data related a video, including still image data, that can be viewed by a user.

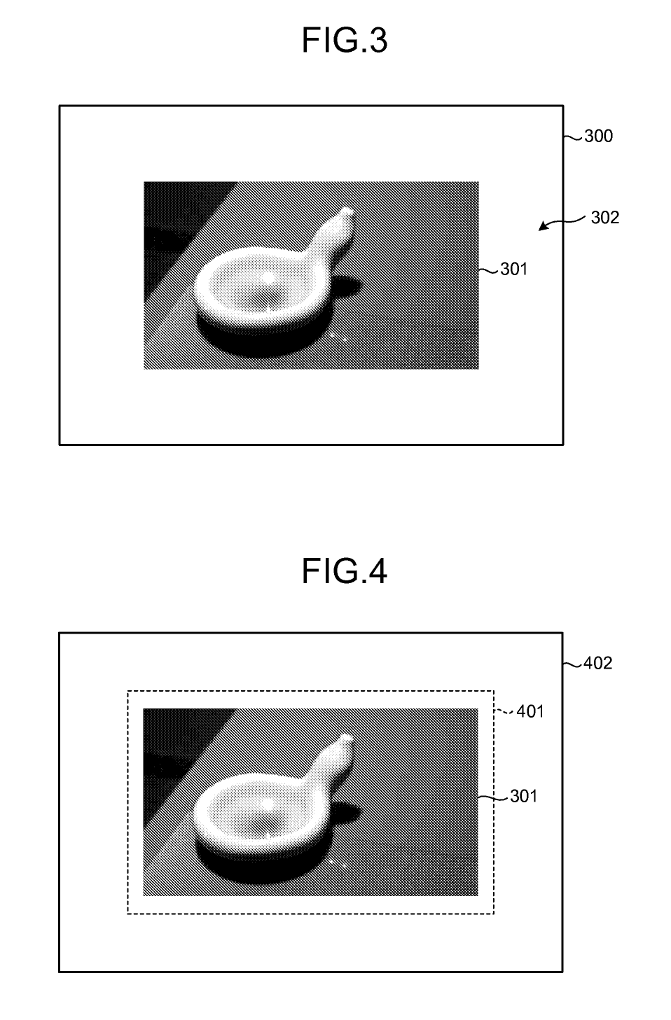

FIG. 3 is a schematic diagram illustrating an example of a video data frame displayed on a display 300 of a conventional television display device. In the example illustrated in FIG. 3, the size of a display area 301 in which the video data is displayed is smaller than the maximum displayable area on the display 300. If the video data in the display area 301 is enlarged to the size of the maximum displayable area of the display 300, the resultant video data becomes rough. Furthermore, if a screen such as a menu is superimposed over the enlarged image data, a portion of the video data becomes not very recognizable.

Without enlarging the video data, nothing will be displayed in a display area 302. The display area 302 can be used effectively if another piece of image data other than the video data is displayed in this area.

However, when another piece of image data is displayed in the display area 302, the viewer will have hard time concentrating on the primary video data displayed in the display area 301.

Therefore, the television display device 100 according to the embodiment generates a piece of extrapolated image data related to the video data to be displayed in the display area 301 as a background of the display area 302, and synthesizes the extrapolated image data with the video data to be displayed in the display area 301. The television display device 100 then superimposes another piece of image data over a portion corresponding to the display area 302. By displaying a resultant output image data superimposed with such image data, the background image that is related to the video data in the display area 301 is displayed around the display area 301. Therefore, the user can easily concentrate on the primary video data, and to refer to the other image data (e.g. a menu or thumbnails of related content). In this manner, the usability for users can be improved.

Human eyes provide two types of visions “central vision” and “peripheral vision”. The central vision is vision having a horizontal visual field of a range of ±15 degrees and uses the central portion of the retinas, thereby providing a highly precise recognition of colors and the shape of a subject. The peripheral vision has a horizontal visual field of ±50 degrees (100 degrees in some cases), and provides unclear vision using peripheral portions of the retinas. Visual information in the peripheral vision can achieve an effect of guiding user's eyes along axes of a coordinate system, thereby allowing the viewer to feel the sense of presence. Although the peripheral vision does not allow a viewer to gain detailed information, the sense of presence can be enhanced by providing the viewer with some information to be recognized as secondary information. In other words, the sense of presence can be achieved by providing an extrapolation related to (based on) the video data around the video data, for example, as an image supplemental to the video data (an image having visual information with the effect of guiding the vision along the axes of the coordinate system and that can create the sense of presence).

Thus, for the case when the display size (resolution, the number of pixels) of the display module is larger than the display size (resolution, the number of pixels) of video data such as that of broadcasting, it is considered to be able to enhance the sense of present by extrapolating supplemental image information around the video data based on (related to) the video data to allow the viewer to recognize that the image is extended (the view angle is extended).

In other words, in the television display device 100 according to the embodiment, when a video related to the video data in the display area 301 is displayed in the display area 302 around the display area 301, video data related to the video data in the display area 301 is displayed on the entire display 300, whereby allowing the sense of presence to be enhanced.

More specifically, a range of a peripheral vision within a horizontal visual field of the ±30 degrees to ±45 degrees is referred to as a stable field of fixation. In the stable field of fixation, a viewer can fixate information effortlessly by moving his or her head. Therefore, the stable field of fixation is suitable as an area for providing information such as a menu that the user wants to see by actively moving his or her head, or items to be operated, without affecting the central view field.

Therefore, in the television display device 100 according to the embodiment, menu items from which a user can make a selection or pieces of information to be provided to a user are displayed in the display area 302 considered to be included in the stable field of fixation. Then, in the television display device 100 according to the embodiment, the background of the menu items or the information is filled with extrapolated image data related to the primary video data. Hence, the television display device 100 according to the embodiment can contribute to the improvement of the sense of presence by the use of the peripheral vision when menu items or related information are not looked by the user, and can provide information such as the menu items to the user only when the user actively direct his or her attention to the display area 302 by moving his or her head.

The image processor 151 according to the embodiment combines a plurality of pieces of extrapolated image data (first extrapolated image data and second extrapolated image data), as a piece of extrapolated image data to be positioned in the display area 302. Specifically, because the first extrapolated image data corresponding to the border portion surrounding the input image data is near the central vision, a first extrapolated image generator 212 generates the first extrapolated image data using a sophisticated processing scheme. By generating the first extrapolated image data with a sophisticated processing scheme, the continuity between the input image data and the first extrapolated image data adjacent to the input image data can be improved.

By contrast, if the image data to be displayed in an area distant from the input image data is generated with a sophisticated processing scheme, the extrapolated image data becomes more different from the actually displayed information, the accuracy of the image data as a piece of image data to be extrapolated becomes reduced, and the entire image becomes more awkward. As an alternative for addressing this issue, a second extrapolated image generator 252, which will be described later, may increase the smoothness of the pixel gradient than that resulting from the first extrapolated image generator 212. As a possible way to achieve this goal, the second extrapolated image generator 252 may use a higher reduction ratio and enlargement ratio (y>x), to generate smoother second extrapolated image data for covering the larger area. Another possible way is to increase the number of taps (an area to be applied with a process) of a smoothing filter (an averaging filter or a Gaussian filter).

In summary, in the embodiment, when a piece of image data for extrapolating the size at which the video data is displayed and the display size of the display 30 is to be generated, the inner side (which is processed by the first extrapolated image generator 212) and the outer side (which is processed by the second extrapolated image generator 252) of the extrapolated image data are generated with different processing schemes. In other words, the first extrapolated image generator 212 generates sophisticated extrapolated image data for the area adjacent to the video data which is considered to be near the central vision to ensure the continuity to the input image data. Then, the second extrapolated image generator 252 generates smoother image data covering the larger area corresponding to the peripheral vision for an area not adjacent to the video data.

Explained in the embodiment is an example in which a plurality of pieces of extrapolated image data are generated, but the embodiment is not limited to an example in which a plurality of pieces of extrapolated image data are generated, and one piece of extrapolated image data may be generated for the display area 302. Furthermore, three or more pieces of extrapolated image data may be generated for the display area 302.

Furthermore, the embodiment is not intended to limit the way in which the area between the display area of the image data and the display area of the display 30 is extrapolated. For example, the extrapolated image data may have an L shape. As another example, when the display size of the video data is 3 to 4, and the display area of the display module is 16 to 9, the image processor 151 may generate a piece of extrapolated image data for extrapolating the area between these two sizes.

FIG. 4 is a schematic diagram for explaining display areas for respective pieces of extrapolated image data that are extrapolated by the image processor 151 in the embodiment. The example in FIG. 4 illustrates a display area 401 for the first extrapolated image data adjacent to a display area 301, and a display area 402 for the second extrapolated image data not adjacent to a display area 301. The image processor 151 according to the embodiment generates the inner first extrapolated image data to have more details, and generates the second extrapolated image data more smoothly to improve the sense of presence. As illustrated in FIG. 4, an outer second extrapolated image data is an image having a larger area than the inner first extrapolated image data. Referring back to FIG. 2, each of the modules will now be explained.

The first extrapolated image processor 202 comprises a 1/x scaler 211, the first extrapolated image generator 212, and an x scaler 213. The first extrapolated image processor 202 mainly generates the first extrapolated image data for extrapolating the display area 401 illustrated in FIG. 4. The first extrapolated image data is a piece of image data adjacent to the input image data, and is generated as sophisticated image data so that users do not feel awkward about the border between the input image data and the first extrapolated image data.

The 1×/x scaler 211 multiples 1×/x to the input image size to generate a piece of input image data reduced to 1/x. x herein is a constant equal to or more than one.

The first extrapolated image generator 212 comprises an extrapolated image generator 221 configured to utilize an image within the same screen, an extrapolated image generator 222 configured to utilize images of video frame, a first video frame buffer 223, and an extrapolated image base generator 224. The first extrapolated image generator 212 generates a piece of first extrapolated image to be assigned to the area adjacent to the input image data, from the input image data reduced to 1×/x.

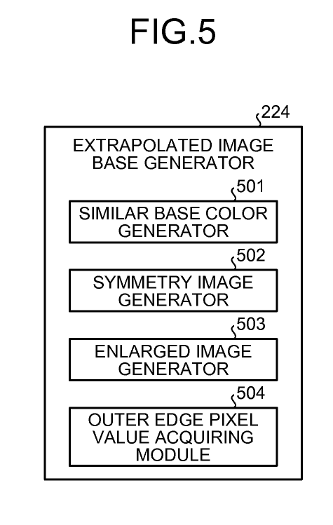

The extrapolated image base generator 224 generates a piece of image data having a display size matching to that of the first extrapolated image data. FIG. 5 is a block diagram illustrating a configuration of the extrapolated image base generator 224. As illustrated in FIG. 5, the extrapolated image base generator 224 comprises a similar base color generator 501, a symmetry image generator 502, an enlarged image generator 503, and a boundary pixel value acquiring module 504.

The similar base color generator 501 extracts the most frequent pixel value in the input image data, and generates a piece of image data assigned with the most frequent pixel value thus extracted as a base color.

The symmetry image generator 502 generates a piece of image data that is line-symmetric to the input image data with respect to the border line between the input image data and the first extrapolated image data. The image data generated by the symmetry image generator 502 is not limited to a symmetric image of the same scale, but may also be enlarged.

The enlarged image generator 503 enlarges the input image data to generate a piece of image data to be used in generating the first extrapolated image data.

The boundary pixel value acquiring module 504 acquires the pixel values along each of the boundary of the input image data, and generates an image by extending the boundary pixel in the normal direction of the corresponding border line.

The extrapolated image base generator 224 synthesizes the pieces of image data generated by the similar base color generator 501, the symmetry image generator 502, the enlarged image generator 503, and the boundary pixel value acquiring module 504.

For example, when the input image data has a color histogram that is extremely biased, the image data generated by the similar base color generator 501 is used at a higher ratio and selected more frequently.

Although the image data generated by the symmetry image generator 502 has continuity with the input image data, the movement in the image data is reversed. Therefore, the extrapolated image base generator 224 uses the image data generated by the symmetry image generator 502 in synthesizing the pieces of image data considering the movement between the frames in the input image data (video data).

The movement in the image data generated by the enlarged image generator 503 follows the movement in the input image data, but less continuous with the input image data. Therefore, when there is a movement equal to or more than a predetermined threshold between the frames in the input image data (video data), the extrapolated image base generator 224 may increase the ratio at which the image data generated by the enlarged image generator 503 is synthesized. On the other hand, when the movement is smaller than the predetermined threshold, the extrapolated image base generator 224 may increase the ratio at which the image data generated by the symmetry image generator 502 is synthesized.

As another alternative, an awkwardness in a symmetric movement can be reduced by performing a smoothing process sufficiently. Therefore, approximately one eighth of the periphery of the image data generated by the symmetry image generator 502 may be applied with a sufficient smoothing process, and the image data applied with the smoothing process is used at a higher synthesizing ratio in the first extrapolated image data than those at which the other pieces of image data are used.

It is also possible to reduce an awkwardness in a video or the like when the boundary of the first extrapolated image data are filled with the image data generated by the boundary pixel value acquiring module 504. When the input image data does not have much characteristics, the image data generated by the boundary pixel value acquiring module 504 may be used as an output of the extrapolated image base generator 224.

The extrapolated image generator 221 uses the input image data in generating a piece of image data that is to be used in generating the first extrapolated image data.

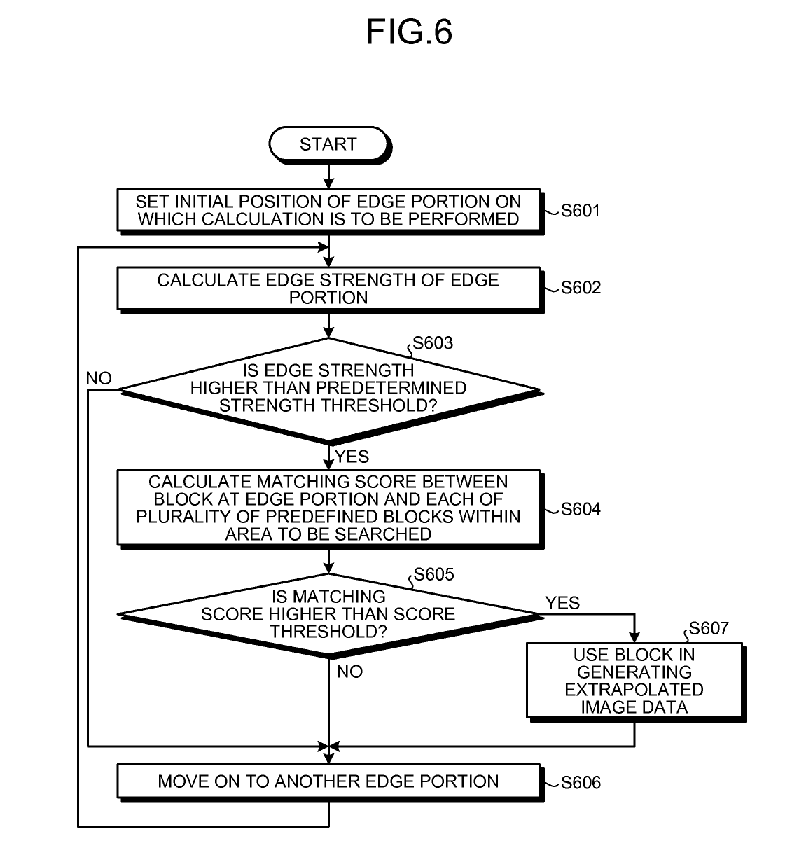

FIG. 6 is a flowchart illustrating a process performed by the extrapolated image generator 221. The process will now be explained with reference to the flowchart.

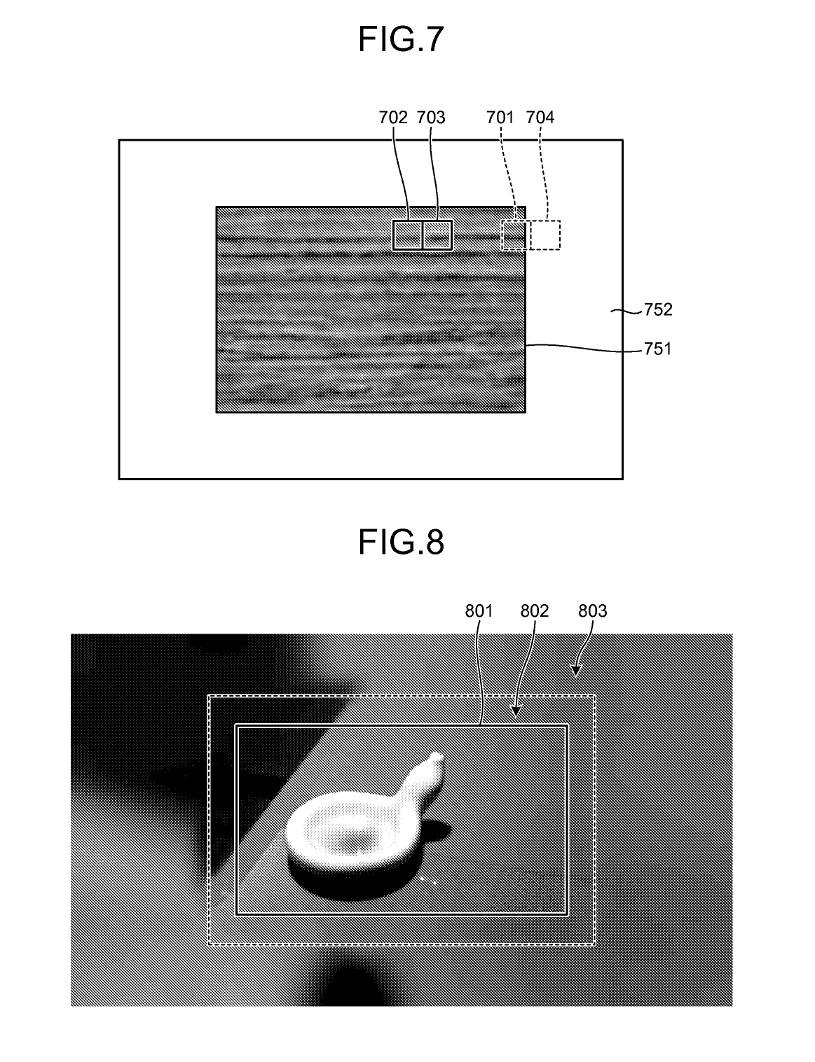

FIG. 7 is a schematic diagram for explaining the image data generated by the extrapolated image generator 221. Explained in FIG. 7 is an example in which, when a display area 752 of the display 30 is extrapolated using image data 751, the extrapolated image generator 221 generates image data near the border around the image data 751.

Referring back to FIG. 6, to begin with, the extrapolated image generator 221 sets an initial position of a border aria on which a calculation is to be performed (S601).

The extrapolated image generator 221 calculates the edge strength in a block at the border aria on which a calculation is to be performed (a reference block 701 in FIG. 7) (S602). The extrapolated image generator 221 determines if the edge strength thus calculated is higher than a predetermined strength threshold (S603). If the edge strength is determined to be equal to or lower than the strength threshold (No at S603), the extrapolated image generator 221 determines that the border aria cannot be used, moves on to another border aria (S606), and repeats the process from 5602.

If the extrapolated image generator 221 determines that the edge strength is higher than the predetermined strength threshold (Yes at S603), the extrapolated image generator 221 calculates a matching score (similarity) between the block at the border aria and each of a plurality of blocks within a predefined area to be searched of the input image data with reference to the block at the border aria (S604).

The extrapolated image generator 221 then determines if the highest one of the matching scores calculated for the respective blocks is higher than a score threshold (S605). If the highest matching score is equal to or lower than the score threshold (No at S605), the extrapolated image generator 221 determines that the border aria cannot be used, moves on to another border aria (S606), and repeats the process from 5602.

If the extrapolated image generator 221 determines that the matching score is higher than the score threshold (Yes at 5605), the extrapolated image generator 221 uses the block with the highest matching score (corresponding block 702 in FIG. 7) and a block adjacent to the block (corresponding adjacent block 703 adjacent to the corresponding block 702) for generation of the extrapolated image data (S607). In other words, because the block at the border aria (the reference block 701 in FIG. 7) is similar to the corresponding block 702, the extrapolated image generator 221 generates image data of a border aria connected block 704 assuming that the border aria connected block 704 is similar to the corresponding adjacent block 703. The extrapolated image generator 221 moves onto another border aria (S606), and repeats the process from 5602.

By repeating this process, the extrapolated image generator 221 generates image data of blocks adjacent to each of the edges.

Referring back to FIG. 2, the first video frame buffer 223 is a buffer temporarily storing therein the input image data. The extrapolated image generator 222 reads the input image data from the first video frame buffer 223, and performs a process using the input image data.

The extrapolated image generator 222 generates a piece of image data to be used in the extrapolated image data using prior input image data that is input prior to the input image data to be used in generating output image data, and is accumulated in the first video frame buffer 223. This image data may be generated using any technique, including those that are known.

The first extrapolated image generator 212 generates the first extrapolated image data by spatially and temporally selecting and synthesizing the pieces of image data generated by the extrapolated image generator 222, the extrapolated image generator 221, and the extrapolated image base generator 224 into an image that is algorithmically different. A technique for selecting and synthesizing the image data is determined based on how the embodiment is implemented. For example, the pieces of image data may be used at different ratios in synthesizing the first extrapolated image data depending on a distance from an border of the input image data. The pieces of image data may be selected and synthesized at different ratios depending on the types of video data.

In this embodiment, when the first extrapolated image generator 212 generates the first extrapolated image data, pieces of image data are synthesized at the ratio (preferentially used) such that the ratio of the piece of image data generated by the extrapolated image generator 222 is the highest, the ratio of the piece of image data generated by the extrapolated image generator 221 is the next highest, and the ratio of the piece of image data generated by the extrapolated image base generator 224 is the lowest.

As the time difference increases between the prior input image data stored in the first video frame buffer 223 used by the extrapolated image generator 222 and the input image data with which the first extrapolated image data is to be synthesized, the prior input image data stored in the first video frame buffer 223 is used in processing a further outer portion. As a further outer portion undergoes processing, the reduction ratio in the 1/X scaler 211 is controlled to be higher.

When the first extrapolated image generator 212 generates the first extrapolated image data, the image data generated by the extrapolated image generator 221 and the image data generated by the extrapolated image generator 222 may be synthesized with the image data generated by the extrapolated image base generator 224, as long as these pieces of data generated by the extrapolated image generator 221 and by the extrapolated image generator 222 are highly reliable.

The x scaler 213 enlarges the first extrapolated image data generated by the first extrapolated image generator 212 by a scaling factor of x. The first extrapolated image data thus enlarged is then output to the selecting and synthesizing module 201.

The second extrapolated image processor 203 comprises a 1/y scaler 251, the second extrapolated image generator 252, and a y scaler 253. The second extrapolated image processor 203 mainly generates the second extrapolated image data for extrapolating the display area 402 illustrated in FIG. 4. The second extrapolated image data is a piece of image data adjacent to the first extrapolated image data, but not adjacent to the input image data, and is generated as a piece of image data requiring a less processing load than that for the first extrapolated image data.

The 1/y scaler 251 multiples the input image size by 1/y, to generate an input image data reduced by a scaling factor of 1/y. y herein is a constant equal to or more than one, and is a number lager than x. This scaling allows the second extrapolated image data to be enlarged larger than the first extrapolated image data, and a smooth image covering a larger area than the first extrapolated image data to be acquired. The first extrapolated image data is an image having more detailed information than the second extrapolated image data.

The second extrapolated image generator 252 comprises an extrapolated image generator 261 utilization of in-screen, an extrapolated image generator 262 utilization of video frame, a second video frame buffer 263, and an extrapolated image base generator 264, and generates the second extrapolated image data to be assigned to the input image data.

The processes performed by the extrapolated image generator 261 utilization of in-screen, the extrapolated image generator 262 utilization of video frame, the second video frame buffer 263, and the extrapolated image base generator 264 comprising the second extrapolated image generator 252 are almost the same as those performed by the extrapolated image generator 221, the extrapolated image generator 222, the first video frame buffer 223, and the extrapolated image base generator 224, respectively, provided to the first extrapolated image generator 212, except a larger area can be filled, because y>x.

The second video frame buffer 263 stores therein the prior input image data that is more prior than that stored in the first video frame buffer 223. The extrapolated image generator 262 utilization of video frame generates a piece of image data to be used in the second extrapolated image data, using the prior input image data having input at time more prior to the prior input data used by the extrapolated image generator 222.

The extrapolated image generator 262 utilization of video frame may also generate the piece of image data to be used in the second extrapolated image data by blending a plurality of pieces of prior input image data stored in the second video frame buffer 263. In such a case, the ratio at which the pieces of prior input image data are blended may be changed depending on difference between the pieces of prior input image data stored in the second video frame buffer 263. For example, when there is a larger difference between the pieces of prior input image data, the older one of the prior input image data in the chronological order is used at a higher ratio, and a movement in the second extrapolated image data is slowed down. Although this type of process maybe performed to the first extrapolated image data to be positioned on the inner side, users tend to feel more awkward about the difference between the current input image data and the prior input image data in an outer display area. Therefore, the ratio tends to be increased more on the inner side.

In contrast to the first extrapolated image generator 212, the second extrapolated image generator 252 selects and synthesizes pieces of image data focusing on blending the brightness and the color of the second extrapolated image data to those of the input image data, rather than on reproducing details, because the second extrapolated image generator 252 generates the image data for an areas corresponding to the peripheral vision. Furthermore, because the peripheral vision is more sensitive to a movement, the second extrapolated image generator 252 generates the second extrapolated image data so as to synchronize a movement in the second extrapolated image data with a movement in the input image data.

The y scaler 253 enlarges the second extrapolated image data generated by the second extrapolated image generator 252 by a scaling factor of y.

In this manner, in the embodiment, the second extrapolated image generator 252 generate the second extrapolated image data, respectively, with a smoother pixel gradient than that the first extrapolated image data, based on the input image data.

The selecting and synthesizing module 201 synthesizes the first extrapolated image data and the second extrapolated image data to the input image data, to generate a piece of synthesized image data having a larger display size. The selecting and synthesizing module 201 synthesizes the first extrapolated image data at a higher ratio on the inner side (in the display area 401 FIG. 4), and synthesizes the second extrapolated image data at a higher ratio on the outer side (e.g., in the display area 402 in FIG. 4).

The selecting and synthesizing module 201 allows the ratio of the first extrapolated image data to be gradually reduced and the ratio of the second extrapolated image data to be gradually increased from the inner side toward the outer side so that viewers do not sense the awkwardness around the boundary between the display area 401 and the display area 402.

Explained in this embodiment is an example in which two different types of extrapolated image data are generated, but the embodiment is not limited to such an example in which two different types of extrapolated image data are generated, and three or more different types of extrapolated image data may also be generated.

FIG. 8 is a schematic diagram illustrating an example of the synthesized image data synthesized by the selecting and synthesizing module 201. In the example illustrated in FIG. 8, the input image data is displayed in a display area 801. The first extrapolated image data is mainly used in the synthesized image data displayed in a display area 802, and the second extrapolated image data is mainly used in the synthesized image data displayed in a display area 803.

The boundary between the display area 802 and the display area 803 is generated in a manner gradually reducing the ratio at which the first extrapolated image data is used and gradually increasing the ratio at which the second extrapolated image data is used from the inner side toward the outer side.

In the display area 802, the synthesized image data is extrapolated sophisticatedly while maintaining the continuity to the input image data, by adopting the generating method described above as a method for generating the first extrapolated image data. By contrast, by adopting the generating method described above as a method for generating the second extrapolated image data, a smoother image covering the larger area corresponding to the peripheral vision can be displayed in the display area 803, and the sense of presence can be improved by taking advantage of the peripheral vision.

When the first extrapolated image data and the second extrapolated image data are synthesized, the selecting and synthesizing module 201 may use a higher synthesized ratio near the center, and may lower the synthesized ratio toward the boundary to allow the awkwardness near the boundary area to be suppressed. Furthermore, the selecting and synthesizing module 201 may use a spatial smoothing filter, when a plurality of algorithms are adjacent to each other. Furthermore, the strength of the smoothing filter maybe increased as the distance from the input image data is increased.

The item image processor 204 comprises a related item generator 271, a related content thumbnail generator 272, and a menu item generator 273.

The related item generator 271 generates a piece of related item image data representing an item for displaying a piece of related information. The related item is an item that a user can select to be provided with information related to the input image data. The related item image data is generated based on the input related data.

The related content thumbnail generator 272 generates a related content thumbnail indicating a piece of related content that is related to the input image data. A piece of related content is a piece of content related to the input image data. The information for generating the related content thumbnail is included in the input related data.

The menu item generator 273 generates menu item image data representing a menu item that can be executed by the television display device 100. Explained in the embodiment is an example in which the menu item image data is generated, but the menu item image data may be stored in the HDD 27 in advance, for example.

The superimposing module 205 superimposes the related item image data, the related content thumbnails, and the menu item image data each of which has an area smaller than the second extrapolated image data over the display area in which the second extrapolated image data is synthesized.

The image information displayed on the television display device 100 according to the embodiment is explained to be the related item image data, the related content thumbnails, and the menu item image data, but the image information may be other types of information without any limitation. Examples of the other information include chapter information of primary video data, weather information, and news. The image information is not limited to pictures, and may be a character string, for example.

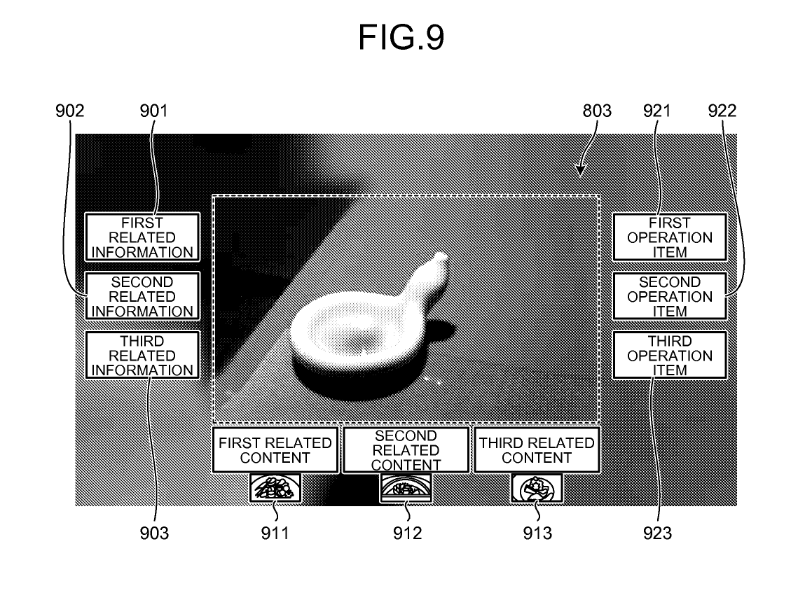

FIG. 9 is a schematic diagram illustrating an example of output image data resulting from superimposing the menu item image data, the related item image data, and the related content thumbnails over the synthesized image data illustrated in FIG. 8

As illustrated in FIG. 9, the pieces of item image data are superimposed over the area outside of the display area 803 (that is, the area in which the second extrapolated image data is synthesized) in the output image data.

Among these pieces of item image data, each of first related item image data 901, second related item image data 902, and third related item image data 903 is an image representing a button for causing a piece of related information to be displayed. When the selection receiver 161 receives a selection of one of these pieces of image data, the television display device 100 causes the related information to be displayed. The related information may be stored in the television display device 100 in advance, or may be received over the network N.

Among the pieces of item image data, each of a first related content thumbnail 911, a second related content thumbnail 912, and a third related content thumbnail 913 is a thumbnail of a piece of content related to the content being displayed as the input image data. When the selection receiver 161 receives a selection of one of the thumbnails, the television display device 100 causes the related content pointed by the selected thumbnail to be displayed. The related content may be stored in the television display device 100 in advance, or may be received over the network N.

When the related content is displayed in the television display device 100 according to the embodiment, the related content serves as the input image data. A piece of extrapolated image data is then generated for the area surrounding the input image data, and the extrapolated image data is synthesized with the input image data (which is the related content) and displayed on the television display device 100. However, displaying of the related content is not limited thereto, and the related content may also be displayed in the entire screen.

Among the pieces of item image data, each of first menu item image data 921, second menu item image data 922, and third menu item image data 923 is an image representing a button for operating the television display device 100. When the selection receiver 161 receives a selection of one of these pieces of image data, the television display device 100 performs control associated with the item image data.

The output module 206 outputs the output image data resulting from superimposing of the pieces of item image data performed by the superimposing module 205 to the display 30 via the synthesizing processor 16 and the video converter 19. In this manner, the screen illustrated in FIG. 9 is displayed.

In the television display device 100 according to the embodiment, by generating a piece of extrapolated image data using the method described above, a smooth image covering a larger area corresponding to the peripheral vision is displayed in the blank area between the display area of the display 30 and the area in which the input image data is displayed. In this manner, the user is allowed to concentrate on the input image data while improving the sense of presence, and to be provided with various types of information and operations only when the user actively pays attention.

Furthermore, in the television display device 100 according to the embodiment, when the second extrapolated image data is generated, details of the image are reduced and smoothing is applied to achieve a smoother luminance gradient so as to improve the visibility of the menu.

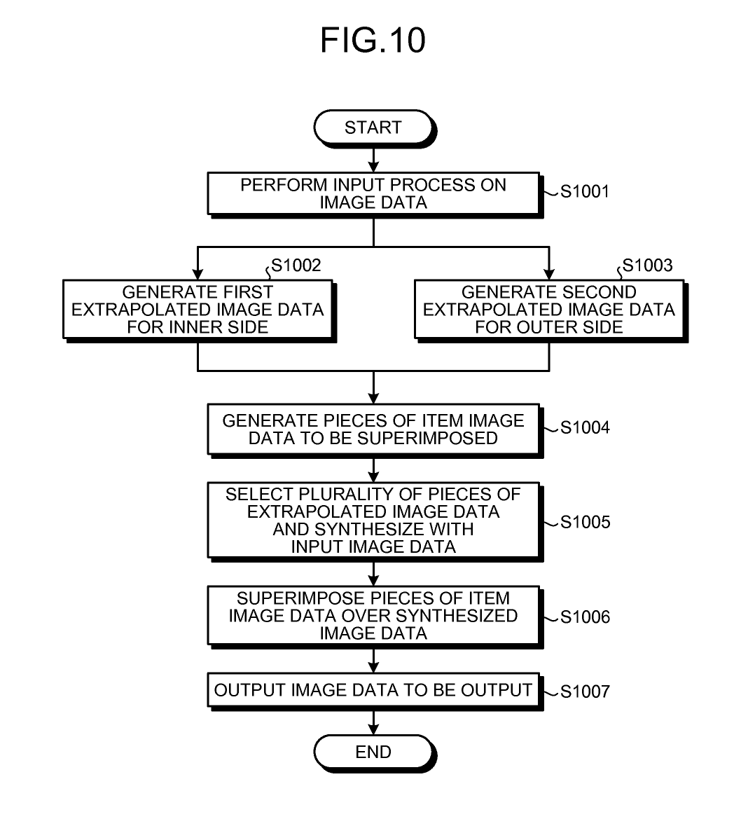

The entire process performed in the image processor 151 according to the embodiment will now be explained. FIG. 10 is a flowchart illustrating the process performed in the image processor 151 in the embodiment.

To begin with, the image processor 151 applies an input process on the input image data (S1001). The first extrapolated image processor 202 then generate the first extrapolated image data for the inner side (S1002). The second extrapolated image processor 203 generates the second extrapolated image data for the outer side (S1003). Because the detailed processes are already described, explanations thereof are omitted hereunder.

The item image processor 204 generates pieces of the item image data (the related item image data, the related content thumbnails, and the menu item image data (to be operated)) to be superimposed (S1004).

The selecting and synthesizing module 201 then selects and synthesizes the input image data, the first extrapolated image data, and the second extrapolated image data, to generate synthesized image data (S1005).

The superimposing module 205 then superimposes the pieces of item image data (the related item image data, the related content thumbnails, and the menu item image data) over an area in which the second extrapolated image data is synthesized in the synthesized image data (S1006). In this manner, image data such as one illustrated in FIG. 9 is generated.

The output module 206 then applies an output process on the output image data (S1007).

### First Modification

Explained in the above-mentioned embodiment is an example in which, when a piece of related content is selected, the related content is used as the input image data and the extrapolated image data is positioned in the blank area surrounding the input image data. However, the embodiment is not limited to the configuration in which the extrapolated image data is provided when a selection of related content is received. For example, the way in which the related content is displayed may be changed depending on whether the related content has a resolution that can be displayed in the entire screen of the television display device 100. Explained in a first modification is an example in which the way in the related content is displayed is changed depending on the resolution of the related content. The configuration of the television display device 100 according to the first modification is assumed to be the same as that according to the embodiment, and an explanation thereof is omitted hereunder.

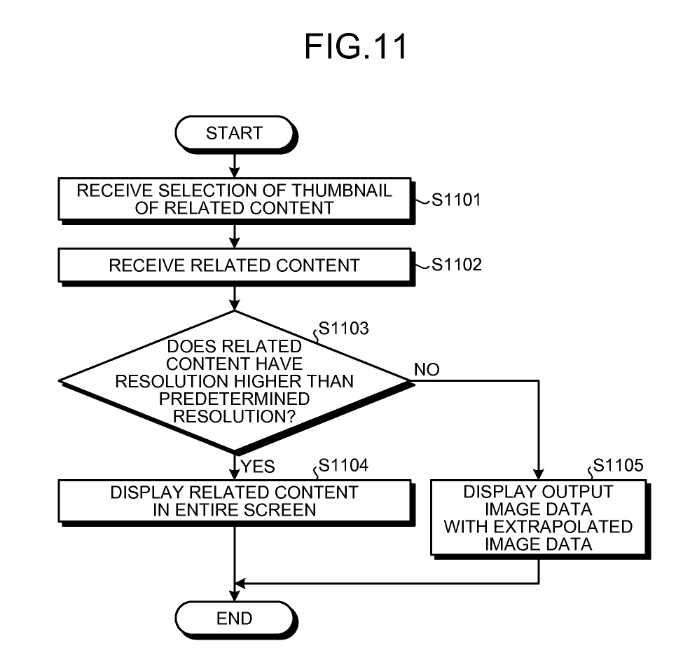

A screen switching process performed in the television display device 100 according to the first modification will now be explained. FIG. 11 is a flowchart illustrating the process performed in the television display device 100 in the first modification. In the flowchart illustrated in FIG. 11, it is assumed that the exemplary screen illustrated in FIG. 9 is currently displayed.

To begin with, the selection receiver 161 receives a selection of a related content thumbnail (the first related content thumbnail 911, the second related content thumbnail 912, or the third related content thumbnail 913) via the remote controller 23 (S1101).

The tuner 13 or the communicating module 29 in the television display device 100 then receives the related content corresponding to the thumbnail for which a selection is thus received (S1102).

The controller 21 then determines if the related content thus received has a resolution equal to or higher than a predetermined resolution (e.g., 1080i or 720p) (S1103).

If the controller 21 determines that the related content has a resolution equal to or higher than the predetermined resolution (e.g., 1080i or 720p) (Yes at S1103), the image processor 151 displays the related content thus received in the entire screen (S1104).

If the controller 21 determines that the related content has a resolution lower than the predetermined resolution (e.g., 1080i or 720p) (No at S1103), the image processor 151 applies the related content as the input image data, in the same manner as in the embodiment described above, and synthesizes a piece of extrapolated image data generated from the input image data to an enlarged area outside of but adjacent to the area in which the input image data is displayed, and outputs an output image data resulting from superimposing thumbnails and various items over the image data thus synthesized (S1105).

In the first modification, displays for the screens are switched depending on the resolution of the related content. In this manner, when the related content has a high resolution, the sense of presence can be improved by displaying the related content in the entire screen. When the resolution of the related content is low, the sense of presence is improved by synthesizing the extrapolated image data to the related content, and the usability for users is improved by providing the users with various types of information.

### Second Modification

Explained in the above-mentioned embodiment is an example in which the pieces of item image data (the first related item image data 901, the second related item image data 902, the third related item image data 903, the first related content thumbnail 911, the second related content thumbnail 912, the third related content thumbnail 913, the first menu item image data 921, the second menu item image data 922, and the third menu item image data 923) are superimposed over the outer side of the display area 803 (that is, over the area in which the second extrapolated image data is synthesized). It is also possible to perform image processing to the area over which these pieces of item image data are superimposed to improve the visibility, without limitation to only superimposing. Explained in a second modification is an example in which image processing is applied to an area near where each of the pieces of item image data is superimposed when the superimposing module 205 superimposes these pieces of item image data over the synthesized image data.

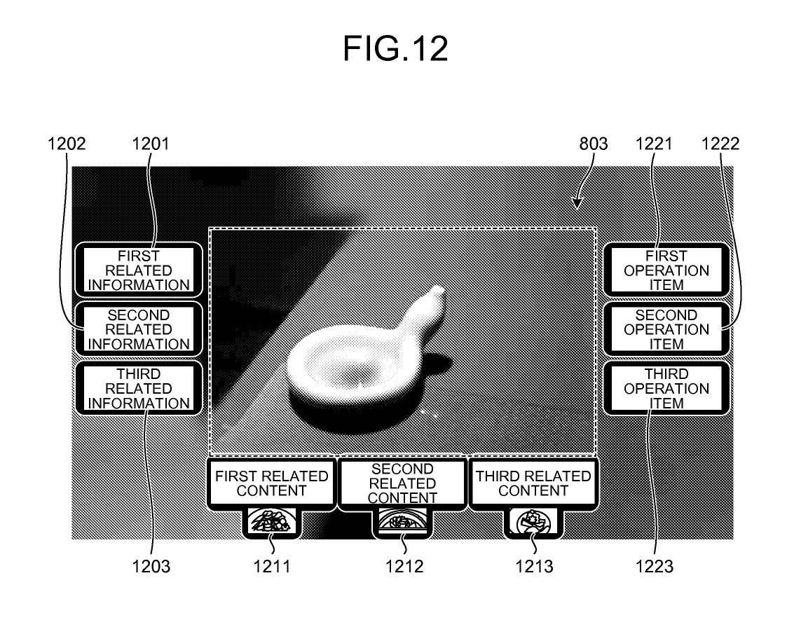

FIG. 12 is a schematic diagram illustrating an example of output image data resulting from performing a process of superimposing pieces of item image data (the menu item image data, the related item image data, and the related content thumbnails) over the synthesized image data in which the extrapolated image data is synthesized, and reducing the luminance near each of these pieces of item image data.

By reducing the luminance of the area near each of the pieces of item image data (menu item image data 1221 to 1223, related item image data 1201 to 1203, related content thumbnails 1211 to 1213), as illustrated in the example in FIG. 12, the border between each of the pieces of item image data and the extrapolated image data can be emphasized so that the visibility is improved.

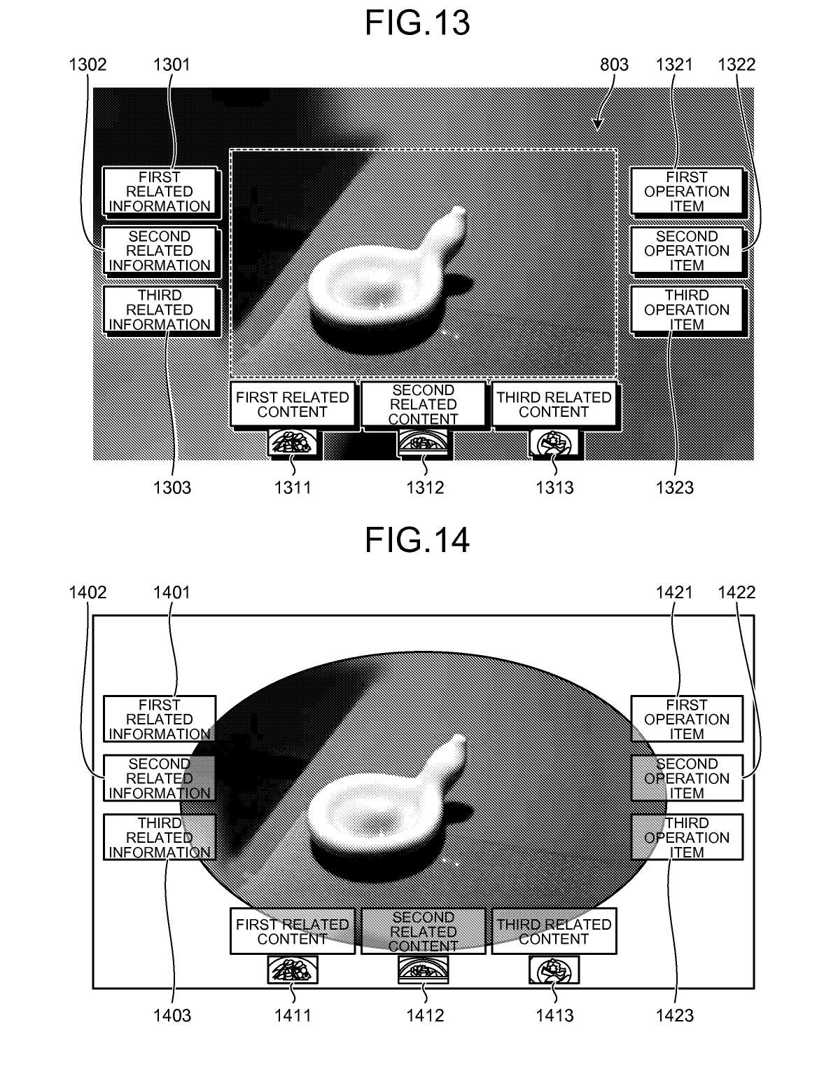

The embodiment is also not limited to reducing the luminance near each of the pieces of item image data. FIG. 13 is a schematic diagram illustrating an example of output image data resulting from performing a process of superimposing pieces of item image data (the menu item image data 1321 to 1323, the related item image data 1301 to 1303, the related content thumbnails 1311 to 1313) over the synthesized image data in which the extrapolated image data is synthesized, and applying image processing so as to allow each of the pieces of item image data to appear as casting a shadow. By reducing the luminance of the area near each of the pieces of item image data in a manner as if the piece is illuminated from one direction by a light source and a shadow is cast from the piece, the border between the piece of item image data and the extrapolated image data can be emphasized so that the visibility is improved.

FIG. 14 is a schematic diagram illustrating an example of output image data resulting from superimposing pieces of item image data (menu item image data 1421 to 1423, related item image data 1401 to 1403, and related content thumbnails 1411 to 1413) over synthesized image data in which extrapolated image data for decorating the periphery of the input image data in an oval shape is synthesized. In the example illustrated in FIG. 14, the ratio at which each of the pieces of item image data (the menu item image data 1421 to 1423, the related item image data 1401 to 1403, and the related content thumbnails 1411 to 1413) generated by the superimposing module 205 is blended with the background is adjusted as the coordinate position of the piece of item image data becomes more distant from the center of the screen. In other words, each of the pieces of item image data is adjusted to as to be more transparent toward the center of the screen, and less transparent toward the periphery of the screen. By transparently (or opaquely) presenting at least part of the area in which each of the pieces of item image data (the menu item image data 1421 to 1423, the related item image data 1401 to 1403, and the related content thumbnails 1411 to 1413) is displayed, the sense of presence can be improved while maintaining the visibility.

Illustrated in FIG. 14 is an example in which the extrapolated image data gradually transits to a white color as the image data approaches the periphery, but the embodiment is not limited thereto. The same extrapolated image data as that according to the embodiment may be used, and the degree of transparency that is the blending ratio of each of the pieces of item image data (the menu item image data 1421 to 1423, the related item image data 1401 to 1403, and the related content thumbnails 1411 to 1413) with the background may be allowed to transit gradually as the piece of item image data becomes more distant from the center of the screen.

### Third Modification

Explained in the embodiment and the modifications described above is an example in which a display processing apparatus is a television display device. However, the display processing apparatus isnot limited to a television display device. Explained now in a third modification is an example in which the display processing apparatus is applied to a portable touch panel operation terminal. As the exemplary screens displayed on the touch panel operation terminal according to the third modifications, the same examples as those mentioned in the embodiment are used.

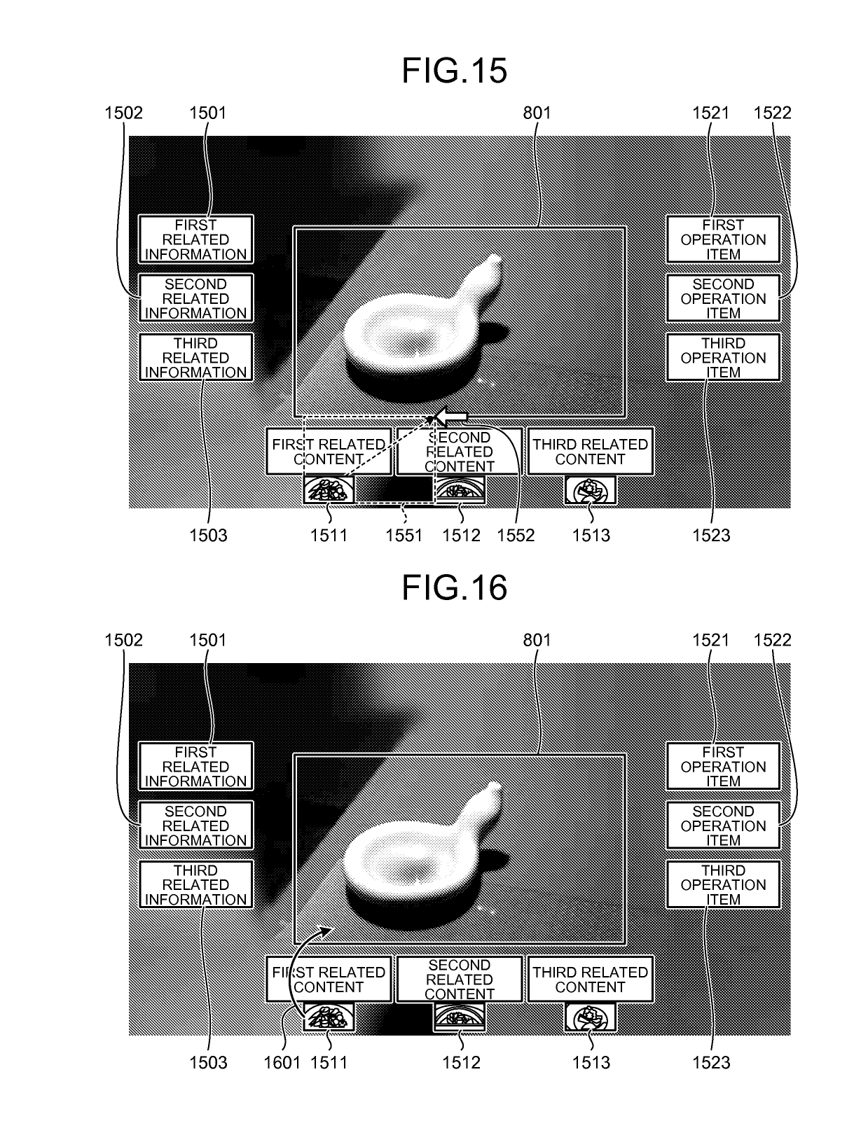

When operations via a touch panel, such as that on a tablet terminal, is applied to the display processing apparatus, users can perform operations unique to a touch panel. FIG. 15 is a schematic diagram illustrating an example of a first operation performed when a selection of related content is received by a touch panel operation terminal. In the example illustrated in FIG. 15, a user selects a piece of item image data (menu item image data 1521 to 1523, related item image data 1501 to 1503, and the related content thumbnails 1511 to 1513) displayed on a touch panel, by directly touching the piece of item image data.

In the third modification, when the user then performs an operation of stretching out the thumbnail of the related content (a pinch-out operation) with his or her fingers (at a position 1552 the fingers are detected), an operation receiver in the touch panel operation terminal receives the operation as an operation 1551 for enlarging the thumbnail of the related content. When the operation receiver receives an operation for extending the thumbnail to a given size or larger, a controller in the touch panel operation terminal starts a process using the related content pointed by the thumbnail as the input image data. An image processor in the touch panel operation terminal then generates extrapolated image data based on the input image data and performs the subsequent process, in the same manner as in the embodiment.

Another operation is still possible. FIG. 16 is a schematic diagram illustrating an example of a second operation performed when a selection of related content is received by the touch panel operation terminal. In the example illustrated in FIG. 16, a user can select and drag a piece of item image data (the menu item image data 1521 to 1523, the related item image data 1501 to 1503, the related content thumbnails 1511 to 1513) on the touch panel (e.g., along a trajectory 1601).

When the user releases his or her finger from the thumbnail of the related content thus dragged in the display area 801 for the input image data, the operation receiver in the touch panel operation terminal receives the operation as an operation for causing the related content to be displayed. The controller in the touch panel operation terminal then starts a process using the related content pointed by the thumbnail as the input image data. The image processor in the touch panel operation terminal then generates extrapolated image data based on the input image data and performs the subsequent process, in the same manner as the process according to the embodiment.

Because the touch panel operation terminal according to the third modification allows users to make operations directly from operation items displayed on the display area, the users can make operations intuitively, whereby allowing the operability to be improved. Furthermore, because the distance of the viewer can be fixed because of the limitation of the length of his or her arm, the view angle of the area for video data can be increased, especially on a display device having a large screen. In this manner, the effect of the peripheral vision can be improved.

Explained in the third modification is an example in which the display processing apparatus is a touch panel operation terminal such as a tablet terminal. However, the embodiment is not limited to a television display device and a tablet terminal, and may be applied to various devices such as a mobile phone terminal, a smartphone, and a personal computer (PC).

### Fourth Modification

Explained in the embodiment and the modifications described above is an example in which the pieces of item image data (the menu item image data, the related item image data, and the thumbnails of related content) are superimposed over the display area in which the extrapolated image data is synthesized. However, these pieces of item image data (menu item image data, related item image data, and thumbnails of related content) do not necessarily need to be positioned on the display area in which the extrapolated image data is synthesized, and these pieces of item image data may be switched to be shown or hidden based on a user operation, without limitation.

Furthermore, the first extrapolated image generator 212 and the second extrapolated image generator 252 may generate different extrapolated image data depending on whether the pieces of item image data (the menu item image data, the related item image data, the related content thumbnail) are superimposed over the extrapolated image data.

When the pieces of item image data (menu item image data, related item image data, and thumbnails of related content) are superimposed, the second extrapolated image generator 252 according to the fourth modification generates second extrapolated image data having a smoother pixel gradient than that generated when the pieces of item image data (menu item image data, related item image data, and thumbnails of related content) are not superimposed. In this manner, when the pieces of item image data (menu item image data, related item image data, and thumbnails of related content) are superimposed, a smoother pixel gradient can be achieved to improve the visibility.

In the embodiment and the modifications described above, the screens described are displayed so that a smooth image covering a larger area corresponding to the peripheral vision is displayed in the blank area between the display area of the display module and the area in which the input image data is displayed. Because the sense of presence is thus improved, the user can concentrate on the input image data at the center, and can be provided with various types of information or operations only when the user actively pays attention. Therefore, the usability for users can be improved. Furthermore, because a user can make operations easily using the operation menu positioned around the input image data, the operability can be improved.

In the display processing apparatus (e.g., the television display device and the touch panel operation terminal such as the tablet terminal) according to the embodiment and the modifications, various types of image data are superimposed over the area in which the extrapolated image data is synthesized. Therefore, menu and the like are no longer superimposed over the input image data, so that a difficulty in seeing some parts of the input image data is overcome.

The image processor 151 according to the embodiment extrapolates the area between the display area of the display 30 and the area in which the input image data is displayed by combining the first extrapolated image data for the inner side and the second extrapolated image data for the outer side. Therefore, detailed depictions can be provided near the boundary between the extrapolated image data and the input image data while maintaining the continuity between these two. Furthermore, smoother depictions covering a large area can be provided correspondingly to the peripheral vision, whereby allowing the sense of presence to be improved by taking advantage of the peripheral vision.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processor comprising:
a generator configured to generate enlarged image data comprising a display area larger than a display area of input image data, the enlarged image data being generated by synthesizing first extrapolated image data and second extrapolated image data with the input image data, the first extrapolated image data being synthesized with respect to a first enlarged area positioned outside of a display area of the input image data and adjacent to the display area of the input image data, the first extrapolated image data comprising continuity with respect to the input image data, the second extrapolated image data being synthesized with respect to a second enlarged area positioned outside the first enlarged area, the second extrapolated image data comprising pixel gradient that is smoother than pixel gradient of the first extrapolated image data; and
a superimposing module configured to superimpose small image data on a display area in which the first extrapolated image data and the second extrapolated image data of the enlarged image data are synthesized, an area of the small image data being smaller than that of the second extrapolated image data.

2. The image processor of claim 1, further comprising:
an output module configured to output the enlarged image data on which the small image data is superimposed by the superimposing module; and
a selection receiver configured to receive a selection of the small image data on the enlarged image data output from the output module.

3. The image processor of claim 2, wherein,
upon receipt of a selection of the small image data by the selection receiver and when second input image data corresponding to the small image data has a resolution lower than a predetermined resolution, the generator is configured to generate second enlarged image data comprising a display area larger than the display area of the second input image data, the second enlarged image data being generated by synthesizing third extrapolated image data with the second input image data, the second enlarged image data being synthesized with respect to an enlarged area positioned outside a display area of the second input image data and adjacent to the display area of the second input image data, the third extrapolated image data being generated to extrapolate the second input image data, and wherein,
the superimposing module is configured to superimpose second small image data on the display area in which the second enlarged image data and the third enlarged image data are synthesized, an area of the second small image data being smaller than an area of the third extrapolated image data.

4. The image processor of claim 3, wherein, upon receipt of a selection of the small image data by the selection receiver and when the second input image data corresponding to the small image data comprises a resolution equal to or higher than a predetermined resolution, the output module is configured to output the second input image data so that the second input image data is displayed in the entire display area of a display.

5. The image processor of claim 1, wherein the generator is configured to generate the enlarged image data by synthesizing the first extrapolated image data and the second extrapolated image data with the input image data, the first extrapolated image data and the second extrapolated image data being generated based on the input image data so that gradient of pixels thereof is smoother than gradient of pixels of the input image data.

6. The image processor of claim 5, wherein whether to superimpose the small image data on the display area in which the first extrapolated image data and the second extrapolated image data of the enlarged image data are synthesized can be switched in the superimposing module, and,
upon the superimposition of the small image data, the generator is configured to generate the enlarged image data by synthesizing the first extrapolated image data and the second extrapolated image data with the input image data, gradient pixels of the first extrapolated image data and the second extrapolated image data being smoother than gradient pixels of the first extrapolated image data and the second extrapolated image data of when the small image data is not superimposed.

7. The image processor of claim 1, wherein, when the small image data having an area smaller than an area of the second extrapolated image data is superimposed on the display area in which the first extrapolated image data and the second extrapolated image data of the enlarged image data are synthesized, the superimposing module is configured to reduce luminance around the small image data, to reduce luminance around the small image data in a manner allowing a portion of the small image data to appear as casting a shadow, or to allow at least a portion of the small image data to appear opaque.

8. The image processor of claim 2, wherein the selection receiver is configured to receive a selection of the small image data via a touch panel comprised in the image processor.

9. An image processing method comprising:
generating enlarged image data comprising a display area larger than a display area of input image data, the enlarged image data being generated by synthesizing first extrapolated image data and second extrapolated image data with the input image data, the first extrapolated image data being synthesized with respect to a first enlarged area positioned outside of a display area of the input image data and adjacent to the display area of the input image data, the first extrapolated image data comprising continuity with respect to the input image data, the second extrapolated image data being synthesized with respect to a second enlarged area positioned outside the first enlarged area, the second extrapolated image data being smoother than the first extrapolated image data; and
superimposing small image data on a display area in which the extrapolated image data of the enlarged image data is synthesized, an area of the small image data being smaller than that of the extrapolated image data.
